(19) United States
(12) Patent Application Publication
(10) Pub. No.: US 2015/0076254 A1
(43) Pub. Date: Mar. 19, 2015

(54) FILTERED SHOWER WAND WITH TWIST-LOCK CONNECTOR

(71) Applicant: David Aaron Farley, Corona, CA (US)

(72) Inventor: David Aaron Farley, Corona, CA (US)

(21) Appl. No.: 14/030,616

(22) Filed: Sep. 18, 2013

(51) Int. Cl. B05B 1/18; C02F 1/00; E03C 1/02

(52) U.S. Cl. CPC B05B 1/185; E03C 1/025; C02F 1/003; C02F 2307/06
USPC 239/532

(57) ABSTRACT

A hand held, filtered shower wand including a spray head, and a handle, the handle defining a handle body with input and output ports, and having a filter media canister. The handle body output port including a first twist-lock connector, and the spray head defining a second twist-lock connector. The first and second twist-lock connectors are engageable to form a seal between the connectors. An O-ring between the connectors provides a watertight seal. The filter media canister may be accessed and replaced by a simple twist of the connectors. The wand spray head provides a plurality of spray settings, using filtered water.

### CROSS-REFERENCE TO RELATED APPLICATIONS

Not Applicable

### STATEMENT OF FEDERALLY SPONSORED RESEARCH/DEVELOPMENT

Not Applicable.

### BACKGROUND

The present invention relates to showering apparatus, such as hand held shower wands. More particularly, the invention concerns a shower wand useful to filter or treat the water stream passing therethrough.

Various devices and systems have been used to treat water used in domestic water systems. Potable water commonly includes contaminates and chemicals, such as chlorine, which kills bacteria in the water. Currently, approximately 80% of all potable water systems in the U.S. utilize chlorine as a disinfectant. However, while serving a positive function of eliminating bacteria, and the like, chlorine may be undesirable in drinking water and can have a harmful effect on human skin and hair. Consequently, it is generally preferable to remove chlorine from drinking water and shower/bath water.

Another characteristic of many potable water systems, particularly water in areas that draw water from certain rivers, is a high mineral content. High mineral content contributes to water hardness. Hardness is typically undesirable in domestic water systems, insofar as it commonly contributes to scaling on glass surfaces, and makes water more difficult to lather, requiring greater amounts of soap, shampoo or the like for showering/bathing.

Various types of systems have been used to filter or treat domestic water systems. Whole house systems, also referred to as point of entry systems, treat the water as it enters the house, e.g. to filter or soften all of the water flowing into the house. Point of use devices, such as shower filters, kitchen sink filters, or refrigerator filters, treat the water at a specific location of the house where the water is used.

Whole house systems are generally effective to remove chemicals or modify water characteristics throughout the house water system. However, while such filtering or treatment may be useful for many uses of water, it may be undesirable for other uses. For example, although chlorine removal may be useful for treating shower water or drinking water, it may not be useful or desirable in relation to remove chlorine from toilet water, sink water, or swimming pool water. Further, chlorine removal may facilitate the growth of bacteria or algae within toilets or plumbing. In some cases the algae can contribute to clogging of shower fixtures and other bacteria conditions in water dispensers.

Whole house water softeners are useful to lower the mineral content of shower water or drinking water. However, many such systems utilize salt to remove the calcium content, which introduces a substantial salt content in the water. That may be undesirable for various water uses, such as watering plants, and can cause difficulties in municipal water treatment systems. Accordingly, such whole house systems and point of use systems each have advantages and disadvantages associated with the different uses of domestic water, e.g. drinking water, shower/bath water, toilet water, pool water, landscape water, etc.

Point of use filtration systems address some of the deficiencies of the whole house systems and allow selective filtration, to suit the various uses of domestic water. For example, shower filters, kitchen sink filters, and refrigerator filters are useful to remove chlorine from the water at the point of use, while retaining chlorine in the water system to serve as antibacterial additive in the toilet water and pool water, and to mitigate the growth of bacteria and algae in the house plumbing.

Shower filtering devices have become increasingly popular and have been implemented in a variety of ways. In-line filters are commonly installed intermediate the shower arm and the showerhead. One such device is the High Output shower filter, marketed by Sprite Industries, Inc. Showerheads have been made to incorporate an internal shower filter, allowing for a more compact arrangement. One such combination showerhead/water filter is the Deluxe 8 All-in-One shower filter marketed by Sprite Industries, Inc.

Shower filters have also been introduced into hand held shower wands, to provide a device which incorporates the convenience of shower wand, with the added functionality of water filter. One such device is the Shower Falls shower wand marketed by Sprite Industries, Inc. In one implementation the filtering media used in such shower wands is contained within a replaceable cartridge insertable in the handle. In another construction, the filtering unit is a permanent portion of the handle, and the filtering unit is replaced by detaching and replacing the handle.

One limitation of such filtered shower wands concerns the weight of the filter media, which is typically a mixture of copper and zinc. The weight of the shower handle may make it difficult to disconnect the handle from the showerhead or the hose, both of which are commonly engaged to the handle by engagement of mating threaded portions. The weight of the handle, space limitations within a shower stall, and the lack of protective clothing and footwear frequently worn during the process, may contribute to injury or damage as with the filtered element is being replaced. More specifically, as one hand holds the showerhead, the other hand may progressively twist and release the handle from the showerhead to the point that the handle may disengage from the shower head when it is not firmly in the grasp of the user, falling on the shower floor or the foot of the user, with considerable force.

In order to mitigate such problems, it is useful to devise an arrangement for connecting an arrangement whereby the shower wand handle and the shower wand head may be engaged and disengaged with a single twist of a user's hand, avoiding the need to progressively grip, twist, and un-grip the weighted shower handle. Such an arrangement not only adds to the convenience of installing and removing the shower wand filter portion, but also enhances the safety of the removal process, particularly when the user is elderly, arthritic, or otherwise has limited manual dexterity to perform the filter element removal.

Further, while such filtered shower wands are useful to remove chlorine and other contaminants from the shower water, they do little to prevent the growth of bacteria, mold, or scaling in the shower stall. The manual removal of such bacteria, mold, scaling may be cumbersome. Space limitations of the shower stalls, and concerns regarding the inhalation of or exposure to cleaning products when applied in full, undiluted strength, in a confined area, each act as deterrents to regular cleaning of shower stalls.

### BRIEF SUMMARY

A hand held, filter shower wand is provided comprising a spray head and handle engageable to the spray head. The handle defines an input port connectable to a flexible water hose, an output port connectable to the spray head, and a handle body having media therein, the handle body being in fluid communication with the handle input port and handle output port.

The handle output port defines a first twist lock connector and the spray head defines a second twist lock connector, engageable to the handle body first twist lock connector. The first and second twist lock connector are formed to provide fluid tight connection between the handle body and the spray head in response to an approximately 90° rotation of the handle body relative to the spray head. Upon disengagement of the handle body from the spray head, the media/filter cartridge is dischargeable from the handle body.

In the presently preferred embodiment the first and second connectors comprise a bayonet connector.

In one embodiment the media is implemented as water filtering media, disposed within a filtered cartridge located within the handle body. In another embodiment, the media is granular water filter media which, upon disengagement of the spray head and the handle body, may be poured into or discharged from the handle body.

The filter media is preferably implemented as zinc or a mixture of copper and zinc.

### BRIEF DESCRIPTION OF THE DRAWINGS

The invention is generally shown by way of reference to the accompanying drawings, FIG. 1 through FIG. 5, in which:

FIG. 1 is a front perspective view of a shower wand embodiment, according to the teachings of the present invention;

FIG. 2 is a side perspective view of the embodiment shown in FIG. 1, exploded to show the spray head, the handle, and a filter media cartridge disposable within the handle, according to the teachings of the present invention;

FIG. 3 is a side view of a spray nozzle assembly embodiment, according to the teachings of the present invention; and

FIG. 4 is an exploded view of the shower head assembly view of the shower wand embodiment shown in FIG. 1, according to the teachings of the present invention.

Some embodiments are described in detail with reference to the related drawings. Additional embodiments, features and/or advantages will become apparent from the ensuing description or may be learned by practicing the invention. In the figures, which are not drawn to scale, like numerals refer to like features throughout the description. The following description is not to be taken in a limiting sense, but is made merely for the purpose of describing the general principles of the invention.

### DETAILED DESCRIPTION

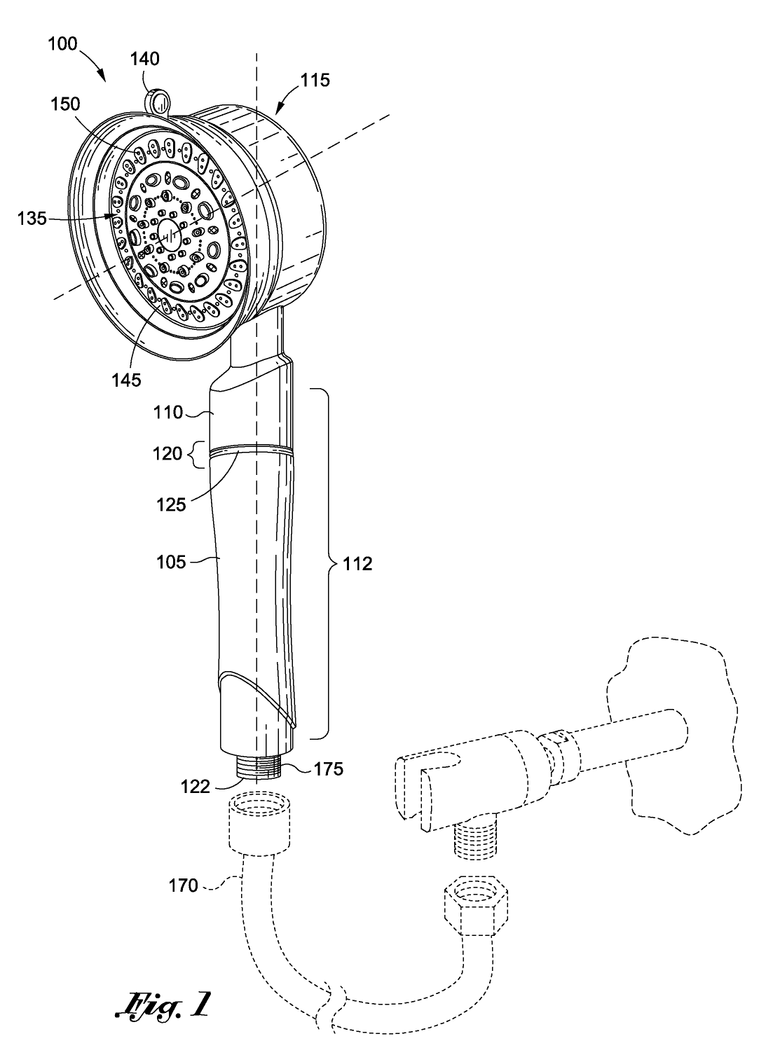

Embodiments herein provide a handheld shower wand and water filter assembly for attachment to a water supply line, to remove chlorine and other substances from the water. The filtered shower wand includes twist-lock connector for ease of changing the water filter. The twist-lock connector can be a bayonet-type connector. Turning to FIG. 1, filtered shower wand 100 includes an elongated, hollow handle 112. Handle 112 can include lower stem 105 and upper stem 110. Spray head 115 can be affixed to upper stem 110. Upper stem 110 can be separable from spray head 115 or may be formed as a unit with spray head 115, as is illustrated in FIG. 1. Upper stem 110 can be removably attached to lower stem 105 using a twist-lock connector 120, which can be sealed with a handle O-ring 125. Twist-lock connector 120 can be of the bayonet-lug assembly type. With this type, bayonet lugs on one element, seat and engage with a locking channel disposed in a second element. Alternately, spray head 115 can be removably attached to upper stem 110, with twist-lock connector sealing the bayonet-type union of the components.

Lower stem 105 can include a threaded portion 107, which may be attached to hose 109 or other flexible mechanism coupled to a water supply line. Threaded portion 107 may include perforated debris screen 109. Coupled together, lower stem 105 and upper stem 110 can be engageable and constitute handle body 112 to spray head 115. In other embodiments, handle 112 can be a single piece, engageable with spray head 115. In a different embodiment, handle 112 defines an input port 122 connectable to a flexible water hose 170, an output port connectable to the spray head 115, and a handle body 112 having water filter media therein, the handle body 112 being in fluid communication with the handle input port 122 and handle output port. Shower wand handle body 112 and the shower spray head 115 may be engaged and disengaged with a single twist of a user's hand. This may be accomplished by a turn of lower stem 105 of handle body 112, relative to the spray head 115, of approximately 90 degrees of rotation, although filtered shower wand 100 may be disassembled by a turn of approximately 30 degrees up to approximately 150 degrees of rotation. A clockwise turn, relative to the longitudinal axis of handle 112, may be used for disassembly, with a counter-clockwise turn being used for re-assembly, for example, after the filter has been changed. Indicia indicating alignment may be imposed on handle body 112 proximate to twist-lock connector 120 such that when rotational alignment is indicated, lower stem 105 can be separated from upper stem 110.

Spray head 115 can include reservoir portion 130. Spray nozzle assembly 135 may be rotatably attached to reservoir portion 130. By rotating spray nozzle assembly 135 relative to reservoir portion 130, a plurality of water patterns at respective water pressures may be obtained by the user. Spray nozzle assembly 135 can be rotated, and respective water patterns actuated, by moving helve 140 about a spray nozzle assembly axis generally acute to the longitudinal axis of handle 112. The plurality of water patterns can be obtained by providing spray nozzle assembly 135 with a plurality of shower nozzles (shown in the aggregate as 150), which may standoff from the surface 145 of the spray nozzle assembly 135 or may be flush with the surface 145. It may be useful to constitute nozzle surfaces of a non-fouling material, to lessen nozzle calcification and mold growth. To facilitate rotation of spray nozzle assembly 135, helve 140 can be coupled to spray nozzle assembly 135. By rotating helve 140, a user can select from one of a plurality of water discharge settings, including, for example, a water discharge setting providing at least one form of massage. As indicated above, handle 112 can be engageable with spray head 115. In selected embodiments, lower stem 105 may be engageable to upper stem 110, which upper stem 110 is unified with spray head 115. Lower stem 105 may be disengaged by a single clockwise twist relative to upper stem 110 and the longitudinal axis of handle 112. Handle 112 may be threadably connectable to flexible hose 170 at threaded input port 175 of lower stem 105, which may be attached to a water source.

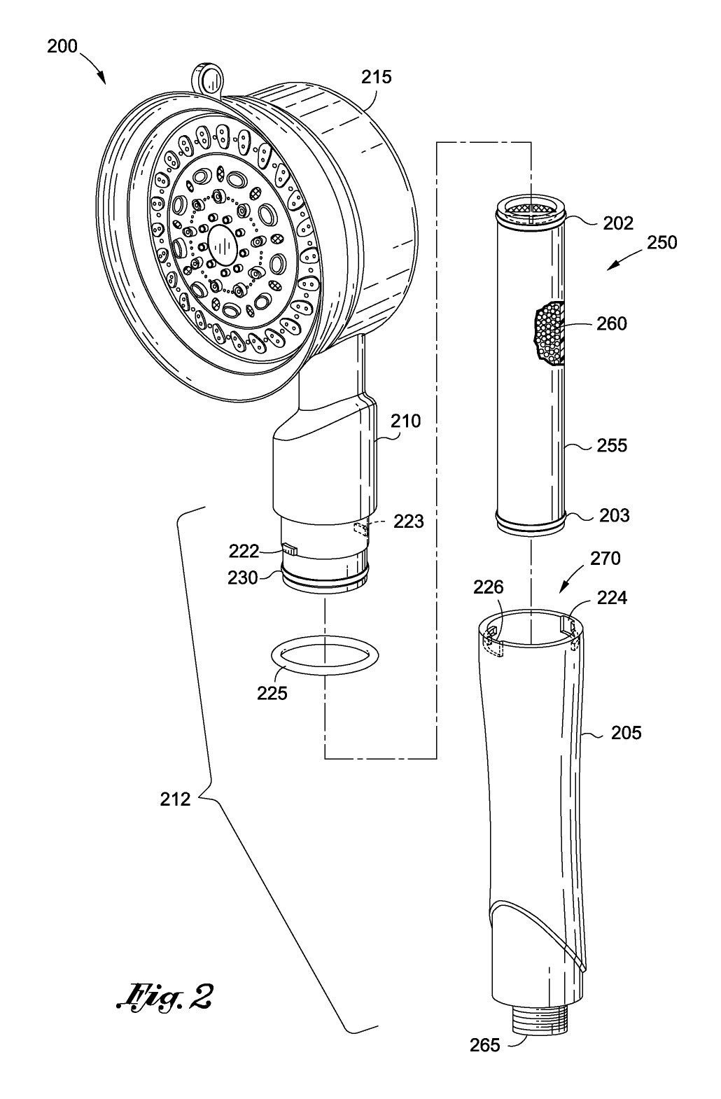

Turning to FIG. 2, filtered shower wand 200 includes spray head 215 and handle 212, which handle 212 can be seen as a handle assembly having filter cartridge 250 therewithin. Wand 200 can be structurally and functionally similar to wand 100, spray head 215 can be functionally similar to spray head 115, and handle 212 can be functionally similar to handle 112. Lugs 222, 223 are operable portions of the twist-lock connector of the bayonet-type. Slotted groove 224, 226 can be configured to lockingly receive lugs (or lands) 222, 223. Filter cartridge 250 can be outfitted with an O-ring 202, 203 on each end, allowing filter 250 to sealingly fit within handle 212. An audible sound may accompany positive seating of O-ring 202, 203. Resilient handle O-ring 225 may be interposed between lower stem 205 and upper stem 210. O-ring 225 provides a waterproof seal between lower stem 205 and upper stem 210. Resilience of O-ring 225 may assist with maintaining a waterproof seal at the juncture of lower stem 205 and upper stem 210, while permitting slight hand-grip pressure to releasingly separate or join stems 205 and 210. In other embodiments, handle O-ring 225 may assist in forming a watertight seal between handle 212. A secondary O-ring 230 may be fitted onto the distal end of upper stem 210 to further enhance the sealing qualities of O-ring 225. Filter cartridge 250 may include a canister 255, in which filter media 260 can be entrapped. Canister 255 can be perforated at each end, having screens secured within each perforation to facilitate trapping of the water filter media within cartridge 250. In use, the water filter media 260 can be exposed to water flowing from inlet port 265 to cartridge outlet port 270, thereby effecting the filtering process. In some embodiments, water filter media 260 can include zinc-copper compounds, such as KDF process media, non-soluble ceramic-type calcium sulfite beads, or both, for example in a 50-50 volumetric combination. An example of such a filter media may be found in U.S. Pat. No. 6,056,875 (Farley) or U.S. Pat. No. 6,016,977 (Farley), which patents are incorporated herein by reference in their respective entirety, although the filter media 260 in cartridge 255 is not limited thereto. An example of such a Ca—Zn—Cu combination media is known as CHLORGON, available from Sprite Industries, Inc., Corona, Calif. USA. KDF process media are products of KDF Fluid Treatment, Inc., Three Rivers, Mich., USA. The water filter media 260 also may be a cleaning media. During the filtering process, at least a portion of chlorine may be removed from influent water, reducing the amount of dissolved chlorine in effluent water ejected from filtered shower wand 200.

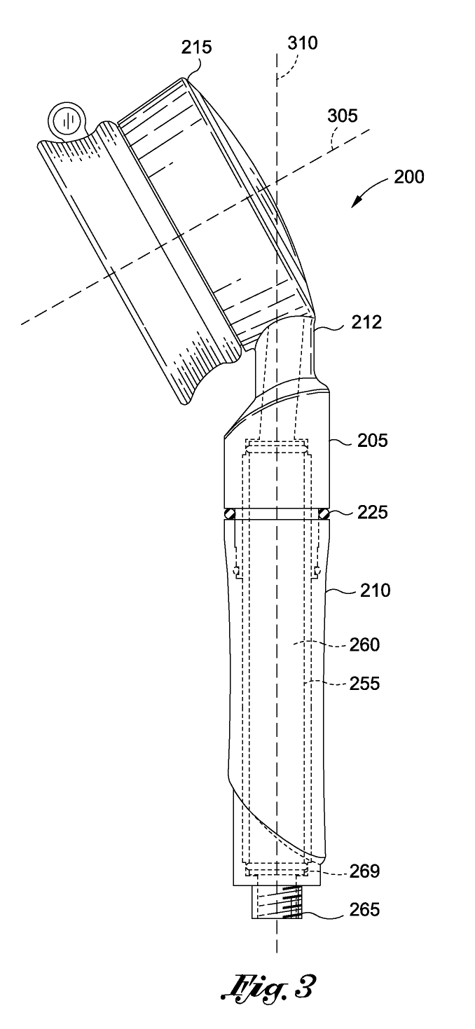

FIG. 3 depicts a side view of an embodiment of a filtered shower wand 200. In some embodiments, spray head 215 axis 305 forms an acute angle with handle 212 axis 310. Handle O-ring 225 can be seen, which forms a waterproof seal between lower stem 205 and upper stem 210. Cartridge 255 contains filter media 260 yet allows a flow path for water entering at inlet port 265, for example, through a threaded connector. Clockwise/counter-clockwise movement of helve 240, relative to axis 305 of spray head 215, can provide a plurality of shower settings from fine spray, to coarse spray, to pulsing massage, with intermediate types of spray settings being possible. Threaded portion of input port 265 may include perforated debris screen 269.

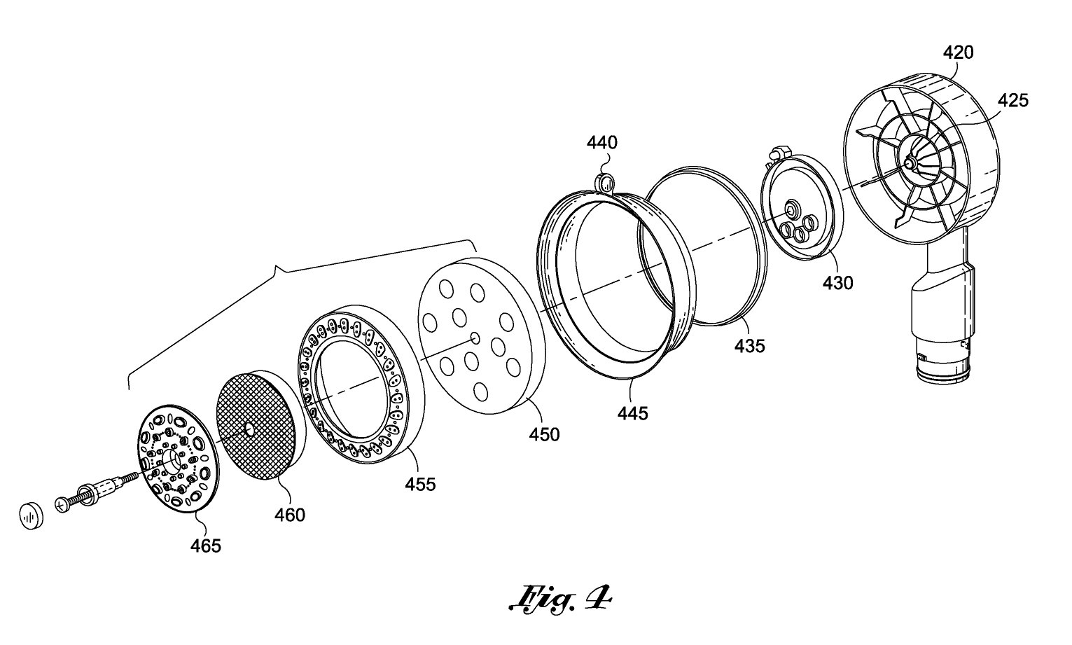

FIG. 4 depicts an exploded view of a shower wand head 415, which may be similar to shower wand head 215. Head 415 includes shower head base 420, from which reservoir nozzle 425 protrudes. Forward of shower head base 420 is positioned flow selector 430. Flow selector 430 is actuated by the movement of helve 440, which rotates bail 445 to provide a selected stream of water to flow diffuser 450. First gasket 435 can be interposed between bail 445 and shower head base 420 to provide a barrier to inadvertent water flow in the shower head 415. Spray nozzle assembly 470 includes constituent elements flow diffuser 450, outer nozzle assembly 455, inner screen assembly 460, and inner nozzle assembly 465. The constituent elements of spray nozzle assembly can be press-fit together and screwed into shower head base 420.

Although the present invention has been described in terms of example embodiments, it is to be understood that neither the Specification nor the Drawings are to be interpreted as limiting. Various alternations and modifications are inherent, or will become apparent to those skilled in the art after reading the foregoing disclosure. It is intended that the appended claims be interpreted as covering all alternations and modifications that are encompassed by the spirit and the scope of the invention.

What is claimed is:

1. A hand held, filtered shower wand comprising:
a spray head, and a handle engageable to the spray head;
the handle defining a handle body with an input port and an output port, and having a media therein, the handle body being in fluid communication with the handle body input port and handle body output port;
the handle body output port defining a first twist-lock connector; and
the spray head defining a second twist-lock connector engageable to the handle body first twist-lock connector, the first and second twist-lock connectors being formed to provide a fluid tight connection between the handle body and the spray head, in response to a rotation of the handle body relative to the spray head.

2. The shower wand recited in claim 1, wherein the first and second connectors comprise a bayonet connector.

3. The shower wand recited in claim 2, wherein the rotation of the handle body relative to the spray head is between approximately thirty (30) degrees and approximately one hundred fifty (150) degrees of rotation.

4. The shower wand recited in claim 1, further comprising a shower hose engageable to the handle body input port.

5. The shower wand as recited in claim 4, wherein the shower hose connector is threadedly engageable to the handle body input port.

6. The shower wand recited in claim 1, wherein the media is entrapped within a filter cartridge disposed within the handle body.

7. The shower wand recited in claim 6, wherein the cartridge contains a water filtering media.

8. The shower wand recited in claim 6, wherein upon disengagement of the spray head and the handle body the filter cartridge is slidably discharged from the handle body.

9. The shower wand recited in claim 1, wherein media contains a water filtering media.

10. The shower wand as recited in claim 1, wherein upon disengagement of the spray head from the handle body, the media is dischargeable from the handle body.

11. The shower wand recited in claim 1, wherein the media comprises a copper and zinc mixture.

12. The shower wand recited in claim 1, wherein the water filtering media comprises a cleaning media.

13. The shower wand recited in claim 7, wherein the media comprises a copper and zinc mixture.

14. The shower wand recited in claim 7, wherein the water filtering media comprises a cleaning media.

15. The shower wand recited in claim 9, wherein the water filtering media comprises a copper and zinc mixture.

16. The shower wand recited in claim 13, wherein the water filtering media further comprises non-soluble ceramic-type calcium sulfite beads.

17. The shower wand recited in claim 15, wherein the water filtering media further comprises non-soluble ceramic-type calcium sulfite beads.

18. The shower wand recited in claim 16, wherein the copper and zinc mixture is disposed with the non-soluble ceramic-type calcium sulfite beads in approximately 50-50 volumetric ratio.

19. The shower wand recited in claim 3, wherein the rotation of the handle body relative to the spray head is approximately ninety (90) degrees.

20. The shower wand recited in claim 1, wherein the second twist-lock connector includes lands engageable to grooves of the handle body first twist-lock connector.
